(19) United States
(12) Patent Application Publication
(10) Pub. No.: US 2026/0267026 A1
(43) Pub. Date: Sep. 10, 2026

(54) MULTI-VECTOR FIELD SOURCE GROUND-TO-AIR ELECTROMAGNETIC EXCITATION GAIN METHOD

(71) Applicant: Jilin University, Changchun, Jilin (CN)

(72) Inventors: Tingting Lin, Changchun, Jilin (CN); Qi Yu, Changchun, Jilin (CN); Shanshan Guan, Changchun, Jilin (CN); Fuxue Yan, Changchun, Jilin (CN); Zekai Liu, Changchun, Jilin (CN)

(21) Appl. No.: 19/012,787

(22) Filed: Jan. 7, 2025

(30) Foreign Application Priority Data
May 16, 2024 (CN) 202410605794.8

(51) Int. Cl. G01V 3/12; G01V 3/17

(52) U.S. Cl. CPC G01V 3/12; G01V 3/17

(57) ABSTRACT

A multi-vector field source ground-to-air electromagnetic excitation gain method is provided, which includes: taking one side of the survey area as the center point of the source area, arranging a multi-vector field source according to the size of the survey area, defining a far field and a near field based on the distance between the field source and the survey area, using a transmitter to achieve multi-source synchronous excitation, and using an unmanned platform carried with a receiving sensor to flight along the survey area in a planned S-shaped measuring line, receiving the vertical magnetic field component H_{z} of the detection target, analyzing to obtain the distribution information of the underground medium of the target area. It improves the excitation energy, detection accuracy and efficiency of the target area, and solves the problems of small excitation energy of traditional single field source.

### CROSS-REFERENCE TO RELATED APPLICATIONS

This application claims to the benefit of priority from Chinese Application No. 202410605794.8 with a filing date of May 16, 2024. The content of the aforementioned applications, including any intervening amendments thereto, are incorporated herein by reference.

### TECHNICAL FIELD

The present disclosure relates to the technical field of ground-to-air electromagnetic detection technology, specifically a multi-vector field source ground-to-air electromagnetic excitation gain method.

### BACKGROUND

Ground-to-air electromagnetic method, as a new type of electromagnetic detection method besides ground electromagnetic method and airborne electromagnetic method, has high detection sensitivity for low resistivity anomalies and plays an indispensable role in the field of metal mineral resource exploration. The ground-to-air electromagnetic method has the advantages of high safety, low cost, and deep exploration of mineral resources. Its basic principle is to use a long wire grounding source or a large-loop source to emit a high-power primary pulse excitation field underground. At this time, an induced secondary field will be generated in the underground geological body. The receiving system carried by unmanned aerial vehicles can quickly and continuously observe the response of the secondary field, and effectively obtain the information of the underground geological body through inversion interpretation. According to the research and application at home and abroad, the ground-to-air electromagnetic method, as an important tool in the fields of energy exploration and resource exploration, has received widespread attention from numerous researchers.

The ground-to-air electromagnetic method also has certain shortcomings. Due to the limitations of traditional single field source excitation and transmission power, there are problems such as small excitation energy in the target area and difficulty of a single field source being too long to arrange, which seriously limits the promotion and application of the ground-to-air electromagnetic method. Therefore, in response to the problems existing in traditional methods, researching target area excitation gain technology to improve excitation energy and accuracy and efficiency of detection is one of the key aspects of ground-to-air electromagnetic technology research.

Chinese patent CN104749640A discloses a “multi-source multi-frequency ground-to-air electromagnetic detection and emission method”, which mainly addresses the problem of insufficient number of detection frequency points and low detection efficiency of single flight. By arranging two or more emission sources in parallel within the emission source area, adjusting the emission frequency of multiple emission sources to achieve synchronous acquisition of multiple emission frequency points. This method can collect multiple frequency points in one flight in the air, effectively improving detection efficiency. However, it cannot directly increase the excitation energy of the target area, and considering the principle that the emission sources must be parallel and independent of each other, the field source effect of this method is further increased, and there are still limitations in the detection direction.

Patent CN111796328A discloses a “multi-source frequency domain ground-to-air electromagnetic detection and acquisition system and method”, by arranging three electrical sources with an angle of 600 in an equilateral triangle on the ground for multi-source and multi-frequency excitation. The intersection point of the perpendicular bisectors of the electric dipole source is located at the center of the observation area, and the three electric dipole sources are in the same direction, clockwise or counterclockwise, to excite the electromagnetic field from multiple angles. This method can effectively improve the accuracy of detecting the planar position of anomalous bodies, but due to the fact that the survey area is located at the center of three field sources, it is difficult to ensure the distance between the survey area and the field sources, resulting in a significant impact on the effective signal by the energy of the field sources. In practical field work, it is mostly in complex terrain areas such as high mountain cutting, and the field sources are arranged in different areas, which makes the work difficult and costly, with low the detection efficiency.

### SUMMARY

The technical problem to be solved by the present disclosure is to provide a multi-vector field source ground-to-air electromagnetic excitation gain method, which improves the excitation energy and the accuracy and efficiency of detection of the target area, and solves the problems of traditional single field source excitation energy being small, single field source being too long to arrange, and low detection efficiency.

The present disclosure is achieved as follows:

A multi-vector field source ground-to-air electromagnetic excitation gain method includes the following steps:

Step 1, taking one side of a survey area as a center point of a source area, using the field strength attenuation formula

$$\frac{{E}_{r}}{{E}_{0}} = {e}^{- \frac{2 π r}{λ}} ,$$

arranging a multi-vector field source according to a size of the survey area, wherein r is a distance between the multi-vector field source and the survey area, E₀ is an initial field strength, Eᵣ is a field strength after propagation distance r, and λ is a wavelength of a uniform stratum.

Step 2, defining a far field and a near field based on the distance between the field source and the survey area, wherein the far field is defined when the distance meets

$$r > \frac{λ}{2 π} ,$$

a transmission waveform is determined as a multi frequency pseudo-random wave, and a transmission frequency ω is determined using a skin depth formula

$$δ = \sqrt{\frac{2}{μωσ}}$$

based on a target detection depth, wherein μ is a ground magnetic permeability, and σσ is a ground conductivity; the near field is defined when the distance meets

$$r < \frac{λ}{2 π} ,$$

the transmission waveform is determined as a bipolar square wave, and a sampling time window is determined using a diffusion depth formula

$$δ = \sqrt{\frac{2 t}{μσ}}$$

based on the target detection depth, wherein t is sampling time, and adjusting a transmission frequency ω of the bipolar square wave.

Step 3, using a transmitter to achieve multi-source synchronous excitation, using an unmanned platform carried with a receiving sensor to flight along the survey area in a planned S-shaped measuring line, receiving a vertical magnetic field component H_{z} of a detection target, and analyzing to obtain distribution information of an underground medium of the detection target.

Wherein the multi-vector field source consists of four transmitting wires, with every two wires on the same vector, forming two vectors perpendicular to each other, the two transmitting wires on the same vector have different current directions, ensuring that the current directions of the two transmitting wires on one vector are the direction facing to each other and the current directions of the two transmitting wires on the other vector are the direction away from each other.

Further, the two transmitting wires on each vector in the multi-vector field source are controlled by the transmitting control circuit of the transmitter to control the transmitting current; the transmitting control circuit includes a first insulate-gate bipolar transistor (IGBT), a second IGBT, a third IGBT, a fourth IGBT, a fifth IGBT, and a sixth IGBT, wherein the first IGBT and the fourth IGBT are connected in series, the second IGBT and the fifth IGBT are connected in series, and the third IGBT and the sixth IGBT are connected in series.

The first IGBT, the fourth IGBT, the second IGBT, and the fifth IGBT form a first H-bridge inverter circuit, and the second IGBT, the fifth IGBT, the third IGBT, and the sixth IGBT form a second H-bridge inverter circuit.

The first H-bridge inverter circuit forms a first transmission circuit with one transmitting wire on the same vector, and the second H-bridge inverter circuit forms a second transmission circuit with another transmitting wire on the same vector.

Further, when the transmitting control circuit transmits in a forward direction, the first IGBT, the third IGBT, and the fifth IGBT are simultaneously in conducting state, and the other IGBTs are in cutoff state, at this time, in the first transmission circuit, current flows forward into the transmitting wire, and in the second transmission circuit, current flows backward into another transmitting wire on the same vector; when the transmitting control circuit transmits in a reverse direction, the second IGBT, the fourth IGBT, and the sixth IGBT are simultaneously in conducting state, while the other IGBTs are in cutoff state, at this time, in the first transmission circuit, current flows in the reverse direction into the transmitting wire, and in the second transmission circuit, current flows in the forward direction into another transmitting wire on the same vector.

A multi-vector field source for ground-to-air electromagnetic excitation gain, wherein the multi-vector field source consists of four transmitting wires, with every two wires on the same vector, forming two vectors perpendicular to each other, the two transmitting wires on the same vector have different current directions, ensuring that the current directions of the two transmitting wires on one vector are the direction facing to each other and the current directions of the two transmitting wires on the other vector are the direction away from each other.

Further, the two transmitting wires on each vector in the multi-vector field source are controlled by the transmitting control circuit of the transmitter to control the transmitting current; the transmitting control circuit includes a first IGBT, a second IGBT, a third IGBT, a fourth IGBT, a fifth IGBT, and a sixth IGBT, wherein the first IGBT and the fourth IGBT are connected in series, the second IGBT and the fifth IGBT are connected in series, and the third IGBT and the sixth IGBT are connected in series.

The first IGBT, the fourth IGBT, the second IGBT, and the fifth IGBT form a first H-bridge inverter circuit, and the second IGBT, the fifth IGBT, the third IGBT, and the sixth IGBT form a second H-bridge inverter circuit.

The first H-bridge inverter circuit forms a first transmission circuit with one transmitting wire on the same vector, and the second H-bridge inverter circuit forms a second transmission circuit with another transmitting wire on the same vector.

Further, when the transmitting control circuit transmits in a forward direction, the first IGBT, the third IGBT, and the fifth IGBT are simultaneously in conducting state, and the other IGBTs are in cutoff state, at this time, in the first transmission circuit, current flows forward into the transmitting wire, and in the second transmission circuit, current flows backward into another transmitting wire on the same vector; when the transmitting control circuit transmits in a reverse direction, the second IGBT, the fourth IGBT, and the sixth IGBT are simultaneously in conducting state, while the other IGBTs are in cutoff state, at this time, in the first transmission circuit, current flows in the reverse direction into the transmitting wire, and in the second transmission circuit, current flows in the forward direction into another transmitting wire on the same vector.

Compared with the prior art, the advantageous effects of the present disclosure are as follows:

The multi-vector field source ground-to-air electromagnetic excitation gain method proposed by the present disclosure enhances the distribution of electromagnetic fields in the target space through the multi-vector source excitation method, breaks through the range limitation of traditional single field source excitation, and improves the problem of difficult source distribution in complex terrain areas. Through the study of the multi-vector field source ground-to-air electromagnetic excitation gain method, the feasibility of the multi-vector field source excitation method has been verified. Compared with traditional methods, the multi-vector field source excitation method has significant advantages in signal quality, detection efficiency, and target recognition, providing new ideas for ground-to-air electromagnetic exploration technology to quickly and finely detect complex terrain areas at large depths, which is of great value for expanding the application scope of ground-to-air electromagnetic exploration technology.

### BRIEF DESCRIPTION OF THE DRAWINGS

FIG. 1 shows a schematic diagram of the multi-vector field source ground-to-air electromagnetic excitation gain method using a multi-vector field source and the detection method of the unmanned aerial vehicle platform equipped with a receiving sensor;

FIG. 2 and FIG. 3 show the circuit schematic diagram of two transmitting wires with the same vector. FIG. 2 shows the current direction during forward transmission, and FIG. 3 shows the current direction during reverse transmission;

FIG. 4 and FIG. 5 are schematic diagrams of the structure of a multi-vector field source provided in an embodiment of the present disclosure, as well as the mesh partitioning constructed in the embodiment. FIG. 4 shows the traditional single 100 m field source method, and FIG. 5 shows the multi-vector field source method;

FIG. 6 and FIG. 7 are schematic diagrams of the arrangement of three-dimensional anomalous bodies in the embodiment, FIG. 6 is a schematic diagram of the direction x-y, and FIG. 7 is a schematic diagram of the direction z-y;

FIG. 8 and FIG. 9 show the calculation results of the target magnetic field components excited by a multi-vector field source and a single field source in the embodiment. Wherein FIG. 8 shows the vertical magnetic field component H_{z} of three-dimensional anomalous body of the single 100 m field source (z=40 m), and FIG. 9 shows the vertical magnetic field component H_{z} of three-dimensional anomalous body of the multi-vector field source (z=40 m).

### DETAILED DESCRIPTION OF THE EMBODIMENTS

In order to make the objective, technical solution, and advantages of the present disclosure clearer and more understandable, the following will provide further detailed illustration of the present disclosure in conjunction with the embodiments. It should be understood that the specific embodiments described herein are only used to explain the present disclosure and are not intended to limit the present disclosure.

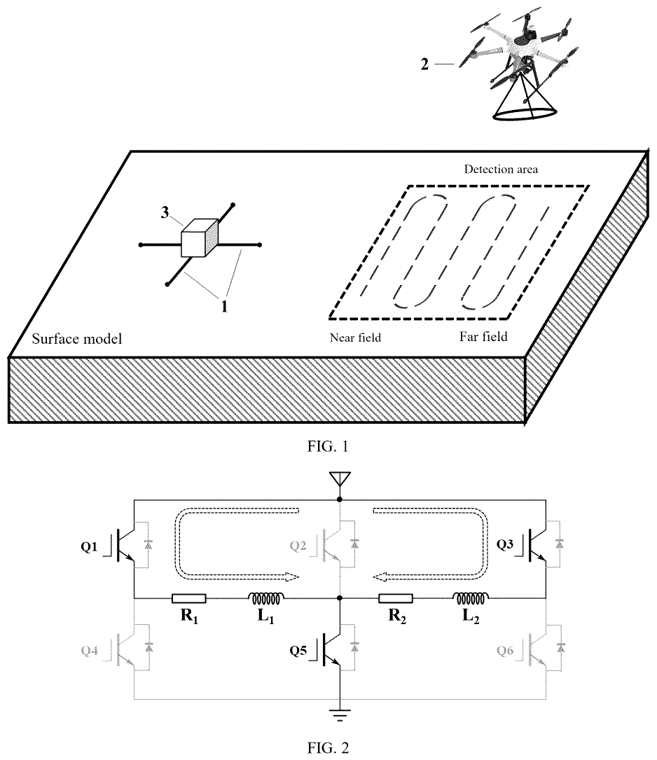

A multi vector field source ground to air electromagnetic excitation gain method, referring to FIG. 1, adopts a transmitter, a multi-vector field source 1, and an unmanned aerial vehicle carried with an aerial receiving platform 2. The method includes the following steps:

Step 1, Planning a survey area, taking one side of the survey area as the center point of a source area, using the field strength attenuation formula

$$\frac{{E}_{r}}{{E}_{0}} = {e}^{- \frac{2 π r}{λ}} ,$$

determining the appropriate length range of 4 or more long wire sources to form a multi-vector field source according to a size of the survey area, to ensure the excitation energy radiates a comprehensive view of the survey area. Wherein r is the distance between the multi-vector field source and the survey area, E₀ is the initial field strength, Eᵣ is the field strength after propagation distance r, and λ is the wavelength of the uniform stratum.

Step 2, observing the geological conditions of the survey area after the multi-vector field source is arranged, defining a far field and a near field based on the distance between the field source and the survey area, wherein the far field is defined when the distance meets

$$r > \frac{λ}{2 π} ,$$

a transmission waveform is determined as a multi frequency pseudo-random wave, and a transmission frequency ω is determined using a skin depth formula

$$δ = \sqrt{\frac{2}{μωσ}}$$

based on a target detection depth, wherein δ is detection depth, μ is the ground magnetic permeability, and σ is the ground conductivity; the near field is defined when the distance meets

$$r < \frac{λ}{2 π} ,$$

the transmission waveform is determined as a bipolar square wave, and a sampling time window is determined using a diffusion depth formula

$$δ = \sqrt{\frac{2 t}{μσ}}$$

based on the target detection depth, wherein δ is detection depth, t is sampling time, μμ is the ground magnetic permeability, and σ is the ground conductivity, and further adjusting a transmission frequency ω of the bipolar square wave.

Step 3, after the transmission parameters are determined, using the unmanned platform carried with a receiving sensor to flight along the survey area in a planned S-shaped measuring line, receiving a vertical magnetic field component H_{z} of a detection target, and analyzing to obtain the distribution information of the underground medium of the detection target.

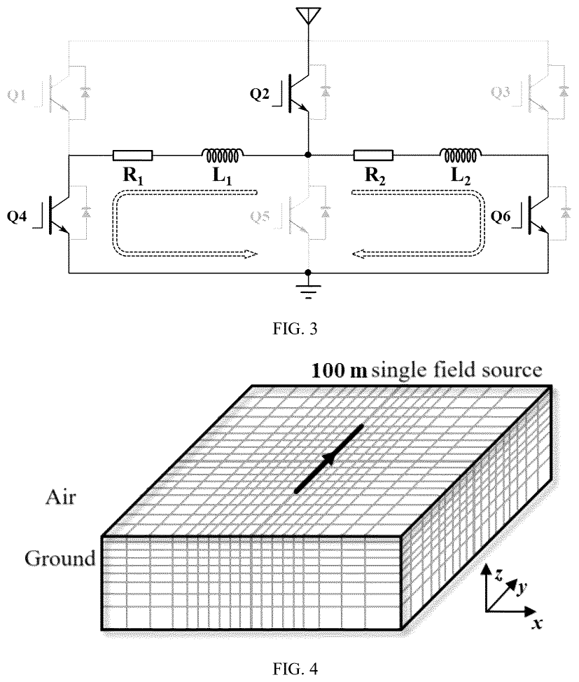

Referring to FIG. 2 and FIG. 3, the multi-vector field source consists of four transmitting wires, with every two wires on the same vector, forming two vectors perpendicular to each other. Wherein, the two transmitting wires on the same vector have different current directions, ensuring that the current directions of the two transmitting wires on one vector are the direction facing to each other and the current directions of the two transmitting wires on the other vector are the direction away from each other.

FIG. 2 and FIG. 3 show the schematic diagrams of the transmission control circuit for two transmitting wires of the same vector in the present disclosure. Taking a single vector as an example, the transmitting control circuit of the transmitter includes a first insulate-gate bipolar transistor (IGBT) Q1, a second IGBT Q2, a third IGBT Q3, a fourth IGBT Q4, a fifth IGBT Q5, and a sixth IGBT Q6, wherein the first IGBT Q1 and the fourth IGBT Q4 are connected in series, the second IGBT Q2 and the fifth IGBT Q5 are connected in series, and the third IGBT Q3 and the sixth IGBT Q6 are connected in series.

The first IGBT Q1, the fourth IGBT Q4, the second IGBT Q2, and the fifth IGBT Q5 form a first H-bridge inverter circuit, and the second IGBT Q2, the fifth IGBT Q5, the third IGBT Q3, and the sixth IGBT Q6 form a second H-bridge inverter circuit.

The first H-bridge inverter circuit forms a first transmission circuit with one transmitting wire on the same vector, and the second H-bridge inverter circuit forms a second transmission circuit with another transmitting wire on the same vector. The two transmitting wires are represented by the resistor R1, the inductor L1, and the resistor R2 and the inductor L2, respectively.

When the transmitting control circuit transmits in a forward direction, the first IGBT, the third IGBT, and the fifth IGBT are simultaneously in conducting state, and the other IGBTs are in cutoff state, at this time, in the first transmission circuit, current flows forward into the transmitting wire, and in the second transmission circuit, current flows backward into another transmitting wire on the same vector, as shown in FIG. 2. When the transmitting control circuit transmits in a reverse direction, the second IGBT, the fourth IGBT, and the sixth IGBT are simultaneously in conducting state, while the other IGBTs are in cutoff state, at this time, in the first transmission circuit, current flows in the reverse direction into the transmitting wire, and in the second transmission circuit, current flows in the forward direction into another transmitting wire on the same vector, as shown in FIG. 3. The transmission process of the other vector is as described above, achieving synchronous excitation gain of the multi-vector field source.

A multi-vector field source for ground-to-air electromagnetic excitation gain is further provided by the present disclosure. The multi-vector field source consists of four transmitting wires, with every two wires on the same vector, forming two vectors perpendicular to each other, the two transmitting wires on the same vector have different current directions, ensuring that the current directions of the two transmitting wires on one vector are the direction facing to each other and the current directions of the two transmitting wires on the other vector are the direction away from each other.

The numerical simulation experiment of the method of the present disclosure is conducted in the programming environment of MATLAB R2021b.

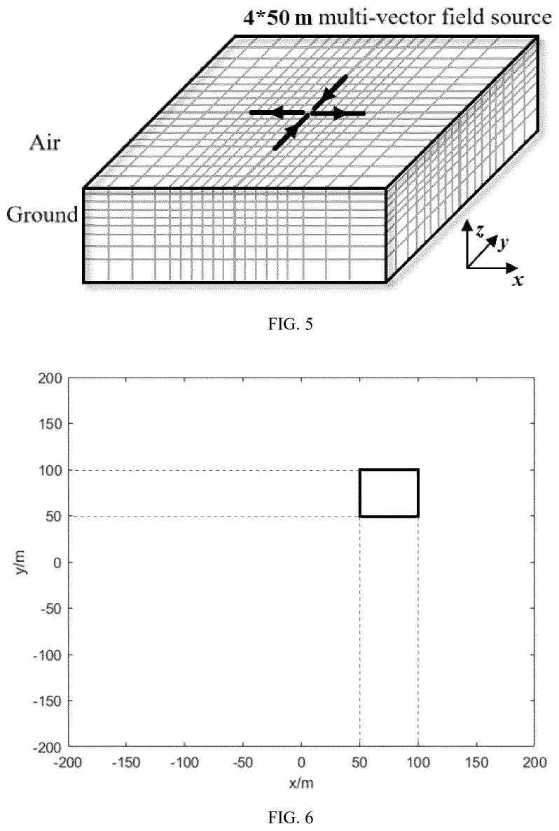

FIG. 4 and FIG. 5 is a schematic diagram of the mesh partitioning constructed in the embodiment. FIG. 4 shows the traditional single 100 m field source method, and FIG. 5 shows the multi-vector field source method. Taking the uniform earth model as an example, mesh partitioning is performed. Dividing the grids of calculation area into upper and lower parts, with the grids in the upper-half area serving as the air layer with a conductivity of 1×106 Ω·m, and the grids in the lower-half serving as the earth model with a resistivity of 100 Ω·m.

The specific calculation area adopts 30×30×30 coarse grids. A 5-meter uniform grid is used for the central area where the excitation source is located, and a variable step grid is used for the peripheral area.

Loading the excitation source position, and loading a multi-vector field source and a single field source separately in the central area. The single field source is set as an one 100 m long wire source in independent excitation, and the multi-vector field source is set as four 50 m long wire sources in excitation together. The initial transmission frequency is 2000 H_{z}, the initial transmitting current is 1A, and the current direction is shown in FIG. 2 and FIG. 3.

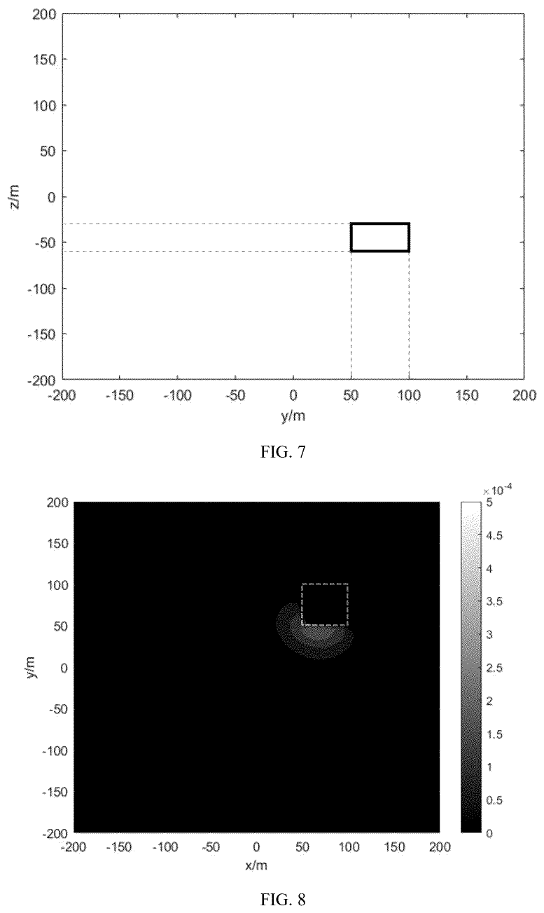

Loading a three-dimensional anomalous body with dimensions of 50 m, 50 m, and 30 m, and setting a resistivity of 1 Ω·m, wherein the three-dimensional anomalous body is located in the upper right corner of the excitation source and buried at a depth of 30 m, as shown in FIG. 6-FIG. 7.

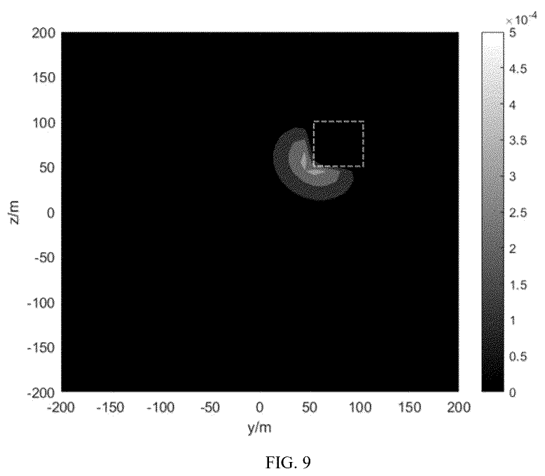

Solving for the magnetic field components H_{z} of the excitation targets under the multi-vector field source and the single field source, the calculation results are shown as FIG. 8 and FIG. 9, wherein FIG. 8 shows the vertical magnetic field component H_{z} of three-dimensional anomalous body of the single 100 m field source (z=40 m), and FIG. 9 shows the vertical magnetic field component H_{z} of three-dimensional anomalous body of a multi-vector field source (z=40 m).

From FIG. 8 and FIG. 9, it can be seen that under the same transmission power of a single source, the multi-vector field source excitation method has a wide range of energy propagation, and the anomalous body position shows more obvious low values. The identification of the anomalous body contour is obvious. The multi-vector field source excitation method has significant advantages in signal quality and target recognition, optimizing the detection direction limitation of traditional single field source, and reducing the power burden of a single field source. Moreover, the field sources are all arranged in the same area, effectively improving the difficulty of the single field source being too long to arrange in complex terrain areas, enhancing detection efficiency, and providing new ideas for the rapid and refined detection of deep and complex terrain areas in ground-to-air electromagnetic detection technology, which is of great value for expanding the application scope of ground-to-air electromagnetic detection technology.

The above description is only a preferred embodiment of the present disclosure and is not intended to limit the present disclosure. Any modifications, equivalent substitutions, and improvements made within the spirit and principles of the present disclosure should be included within the scope of the present disclosure.

1. A multi-vector field source ground-to-air electromagnetic excitation gain method, comprising:
step 1, taking one side of a survey area as a center point of a source area, using the field strength attenuation formula
$$\frac{{E}_{r}}{{E}_{0}} = {e}^{- \frac{2 π r}{λ}} ,$$
arranging a multi-vector field source according to a size of the survey area, wherein rr is a distance between the multi-vector field source and the survey area, E₀ is an initial field strength, Eᵣ is a field strength after propagation distance r, and λ is a wavelength of a uniform stratum;
step 2, defining a far field and a near field based on the distance between the field source and the survey area, wherein the far field is defined when the distance meets
$$r > \frac{λ}{2 π} ,$$
a transmission waveform is determined as a multi frequency pseudo-random wave, and a transmission frequency ω is determined using a skin depth formula
$$δ = \sqrt{\frac{2}{μωσ}}$$
based on a target detection depth, wherein μ is a ground magnetic permeability, and σσ is a ground conductivity; the near field is defined when the distance meets
$$r < \frac{λ}{2 π} ,$$
the transmission waveform is determined as a bipolar square wave, and a sampling time window is determined using a diffusion depth formula
$$δ = \sqrt{\frac{2 t}{μσ}}$$
based on the target detection depth, wherein t is sampling time, and adjusting a transmission frequency ω of the bipolar square wave;
step 3, using a transmitter to achieve multi-source synchronous excitation, using an unmanned platform carried with a receiving sensor to flight along the survey area in a planned S-shaped measuring line, receiving a vertical magnetic field component H_{z} of a detection target, and analyzing to obtain distribution information of an underground medium of the detection target;
wherein the multi-vector field source consists of four transmitting wires, with every two wires on the same vector, forming two vectors perpendicular to each other, the two transmitting wires on the same vector have different current directions, ensuring that the current directions of the two transmitting wires on one vector are the direction facing to each other and the current directions of the two transmitting wires on the other vector are the direction away from each other.

2. The multi-vector field source ground-to-air electromagnetic excitation gain method according to claim 1, wherein the two transmitting wires on each vector in the multi-vector field source are controlled by the transmitting control circuit of the transmitter to control the transmitting current; the transmitting control circuit comprises a first insulate-gate bipolar transistor (IGBT), a second IGBT, a third IGBT, a fourth IGBT, a fifth IGBT, and a sixth IGBT, wherein the first IGBT and the fourth IGBT are connected in series, the second IGBT and the fifth IGBT are connected in series, and the third IGBT and the sixth IGBT are connected in series;
the first IGBT, the fourth IGBT, the second IGBT, and the fifth IGBT form a first H-bridge inverter circuit, and the second IGBT, the fifth IGBT, the third IGBT, and the sixth IGBT form a second H-bridge inverter circuit;
the first H-bridge inverter circuit forms a first transmission circuit with one transmitting wire on the same vector, and the second H-bridge inverter circuit forms a second transmission circuit with another transmitting wire on the same vector.

3. The multi-vector field source ground-to-air electromagnetic excitation gain method according to claim 2, wherein when the transmitting control circuit transmits in a forward direction, the first IGBT, the third IGBT, and the fifth IGBT are simultaneously in conducting state, and the other IGBTs are in cutoff state, at this time, in the first transmission circuit, current flows forward into the transmitting wire, and in the second transmission circuit, current flows backward into another transmitting wire on the same vector; when the transmitting control circuit transmits in a reverse direction, the second IGBT, the fourth IGBT, and the sixth IGBT are simultaneously in conducting state, while the other IGBTs are in cutoff state, at this time, in the first transmission circuit, current flows in the reverse direction into the transmitting wire, and in the second transmission circuit, current flows in the forward direction into another transmitting wire on the same vector.

4. A multi-vector field source for ground-to-air electromagnetic excitation gain, wherein the multi-vector field source consists of four transmitting wires, with every two wires on the same vector, forming two vectors perpendicular to each other, the two transmitting wires on the same vector have different current directions, ensuring that the current directions of the two transmitting wires on one vector are the direction facing to each other and the current directions of the two transmitting wires on the other vector are the direction away from each other.

5. The multi-vector field source according to claim 4, wherein the two transmitting wires on each vector in the multi-vector field source are controlled by the transmitting control circuit of the transmitter to control the transmitting current; the transmitting control circuit comprises a first IGBT, a second IGBT, a third IGBT, a fourth IGBT, a fifth IGBT, and a sixth IGBT, wherein the first IGBT and the fourth IGBT are connected in series, the second IGBT and the fifth IGBT are connected in series, and the third IGBT and the sixth IGBT are connected in series;
the first IGBT, the fourth IGBT, the second IGBT, and the fifth IGBT form a first H-bridge inverter circuit, and the second IGBT, the fifth IGBT, the third IGBT, and the sixth IGBT form a second H-bridge inverter circuit;
the first H-bridge inverter circuit forms a first transmission circuit with one transmitting wire on the same vector, and the second H-bridge inverter circuit forms a second transmission circuit with another transmitting wire on the same vector.

6. The multi-vector field source according to claim 5, wherein when the transmitting control circuit transmits in a forward direction, the first IGBT, the third IGBT, and the fifth IGBT are simultaneously in conducting state, and the other IGBTs are in cutoff state, at this time, in the first transmission circuit, current flows forward into the transmitting wire, and in the second transmission circuit, current flows backward into another transmitting wire on the same vector; when the transmitting control circuit transmits in a reverse direction, the second IGBT, the fourth IGBT, and the sixth IGBT are simultaneously in conducting state, while the other IGBTs are in cutoff state, at this time, in the first transmission circuit, current flows in the reverse direction into the transmitting wire, and in the second transmission circuit, current flows in the forward direction into another transmitting wire on the same vector.
